(19) United States
(12) Patent Application Publication
(10) Pub. No.: US 2002/0189473 A1
(43) Pub. Date: Dec. 19, 2002

(54) Washing bar for a printing press cylinder

(76) Inventor: Torsten Schmutz, Bobingen (DE)

Correspondence Address: OSTROLENK FABER GERB & SOFFEN, 1180 AVENUE OF THE AMERICAS, NEW YORK, NY, 100368403

(21) Appl. No.: 10/169,587

(22) PCT Filed: Jan. 5, 2001
(86) PCT No.: PCT/EP01/00065

(30) Foreign Application Priority Data
Jan. 8, 2000 (DE) 100005497

(51) Int. Cl. B41F 35/00; B41L 41/00

(52) U.S. Cl. 101/425

(57) ABSTRACT

The invention relates to a washing bar (2) for a printing press cylinder (4). A spray pipe (50) is inserted into a channel (56) and is radially supported therein and detachably fastened at both pipe ends by fastening means (58-1, 58-2). The pipe (50) can be removed from the washing bar (2) when only one of the fastening means (58-1, 58-2) has been detached.

The invention relates to a washing bar for printing press cylinders according to the preamble of claim 1.

A washing bar of this type is disclosed by U.S. Pat. No. 4,344,361.

Accordingly, the invention relates to a washing bar for printing press cylinders, containing a pressing element for pressing a washing cloth section of a washing cloth onto the peripheral surface of a cylinder to be cleaned, at least one holding element which holds the pressing element in a predetermined position, bearings for the rotatable mounting of a clean-cloth roller and a dirty-cloth roller, in each case at their roller ends, in side parts, in order to move the washing cloth from the clean-cloth roller over the pressing element onto the dirty-cloth roller, a spray pipe, which is arranged beside the movement path of the washing cloth in order to moisten the washing cloth.

A printing press cylinder to be washed by the washing bar is in particular a blanket cylinder of an offset printing press, but can also be any other type of cylinder of an offset printing press or another printing press.

In a prior art known from practice, the spray pipe is welded onto a cloth deflection plate around which the washing cloth is deflected. As a result, the spray pipe cannot be removed from the washing bar without the cloth deflection plate, for example in order to clean or to replace said pipe. For this purpose, a large number of screws have to be dismantled.

The invention is intended to achieve the object of providing a possible way by means of which the spray pipe can be mounted and dismantled in a simpler way and more quickly.

According to the invention, this object is achieved by the characterizing features of claim 1.

According to the invention, a washing bar for printing press cylinders is characterized in that the spray pipe is inserted into a channel of the holding element and is supported therein by the holding element, and in that fastening means are provided for the detachable fastening of the spray pipe at both pipe ends.

The invention has the advantage that the spray pipe can be mounted and dismantled by a fastening means being detached only at its one end. This fastening means is preferably designed in such a way that it can be used at the same time as a liquid connection element to feed liquid, for example water, into the spray pipe.

According to a special embodiment of the invention, provision is made for the fastening means at at least one pipe end to have a mount into which the pipe end can be inserted axially in a liquid-tight manner and from which it can be removed axially, and for the fastening means of at least the relevant other pipe end to be arranged such that it can be removed in such a way that after the removal of this fastening means, the pipe can be removed axially from the mount of the one fastening means, and for the fastening means at at least one pipe end to be a liquid connection element for feeding liquid into the pipe end held by it.

The fastening means is preferably fastened to the cross member such that it can be removed. According to another embodiment, however, it can also be arranged on the cross member such that it can be displaced in the pipe longitudinal direction and, as a result, can be pulled off the pipe end or pushed onto the pipe. According to another possibility, the fastening means can be connected to the holding element of the pressing element such that it is detachable or can be displaced in the pipe longitudinal direction.

Likewise, according to a preferred embodiment according to the invention, the fastening means at both pipe ends are designed as liquid feed elements.

Further features of the invention are contained in the subclaims.

The invention will be described in the following text with reference to the drawings and using preferred embodiments as examples. In the drawings:

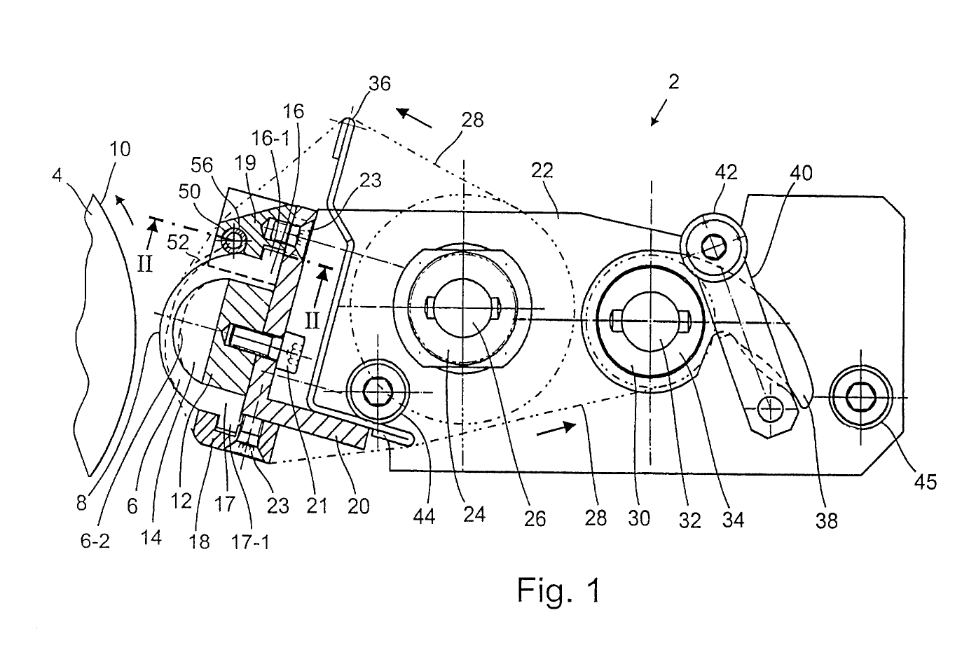

FIG. 1 shows, in schematic form, a side view of a washing bar according to the invention for washing the peripheral surface of a printing press cylinder,

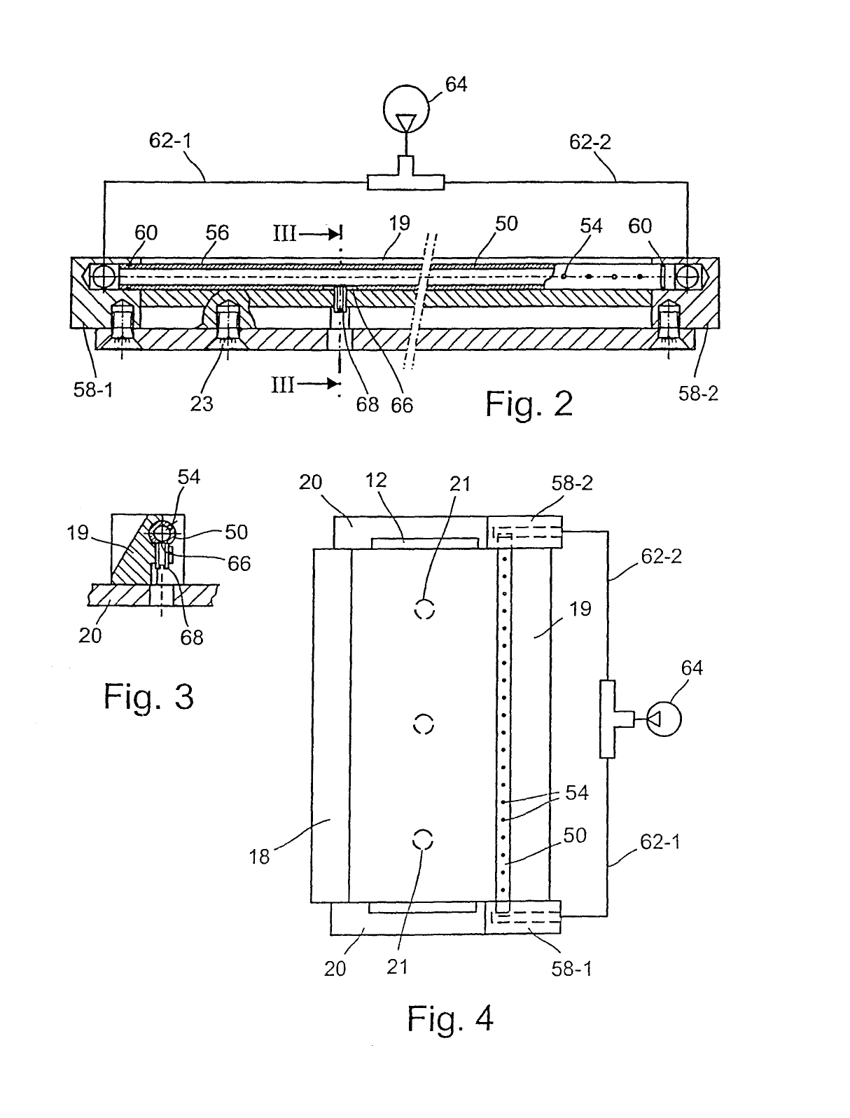

FIG. 2 shows a longitudinal view of a spray pipe from FIG. 1 with the elements holding it, substantially in the plane II-II from FIG. 1, viewed in the direction of the arrows there,

FIG. 3 shows a cross-sectional view along the plane III-III from FIG. 2, viewed in the direction of the arrows there,

FIG. 4 shows, not to scale, a front view of significant parts of the washing bar, viewed from the printing press cylinder,

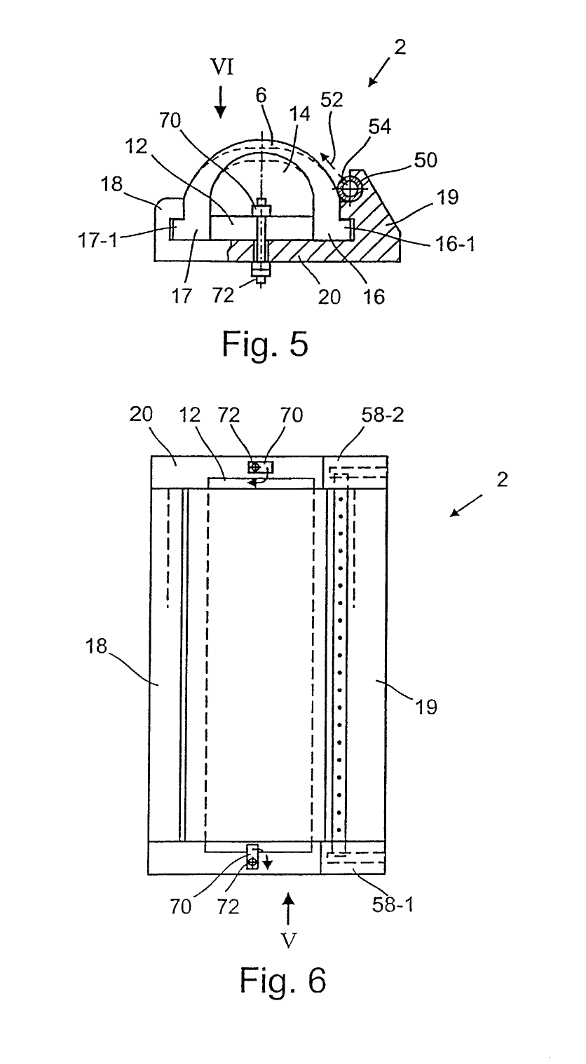

FIG. 5 shows a side view, not to scale, of a further embodiment of a holding device according to the invention, by means of which a washing cloth pressing element and a spray pipe can be replaced quickly,

FIG. 6 shows a plane view of the embodiment of FIG. 5.

The washing bar 2 for printing press cylinders 4, shown in the drawings, contains a pressing element 6 for pressing a washing cloth section 8 onto the peripheral surface 10 of the cylinder 4 to be cleaned. The pressing element 6 is preferably a flexible lip made of rubber or plastic. According to FIG. 1, as viewed in cross section, it has a substantially half-round or U-shaped tunnel roof shape and, between itself and an inner bar, a cavity 14. The cavity 14 can be inflated in order to make contact and press the pressing element 6 onto the cylinder 4 with the washing cloth section 8 lying between them. According to the embodiment illustrated in the drawings, the cavity 14 cannot be inflated. Dashed lines 6-2 show how the pressing element 6 can be deformed by the cylinder 4. The washing bar 2 can be advanced automatically, by a drive not shown, from the base position shown in FIG. 1, in which the pressing element 6 is at a distance from the cylinder 4, into a washing position, in which the pressing element 6 presses the washing cloth section 8 lying on it onto the peripheral surface 10 of the cylinder 4, and then back into the base position again. Following or during withdrawal of the washing bar 2 from its washing position into its base position, the pressing element 6 again assumes its original shape, illustrated by continuous lines, because of its intrinsic resilience.

The longitudinal edges 16 and 17 of the pressing element 6are clamped in between a cross member 20, the inner bar 12 and outer holding bars 18 and 19, which each extend over the entire length of the pressing element 6 and are fastened to the cross member 20 by screws 21 and 23 or by quick-connection elements (clamping wedge or the like).

Following the removal of the screws 21 or the release of the quick-connection elements of the inner bar 12, this inner bar 12 can be drawn out of the pressing element 6 in the bar longitudinal direction. The pressing element 6 can then be drawn out between the outer bars 18 and 19 in the bar longitudinal direction or can be compressed transversely with respect to the outer bars 18 and 19 and therefore freed from the latter and then removed transversely or longitudinally. The insertion of the pressing element 6 and the inner bar 12 between the outer bars 18 and 19 is carried out in the reverse order.

The longitudinal edges 16 and 17 of the pressing element 6 are seated on the cross member 20 and each have an edge protrusion 16-1 and 17-1 which projects away outward and over which the adjacent outer holding bar 18 or 19 engages.

The cross member 20 connects side parts 22 of the washing bar to each other.

In the side parts 22 there are bearings 24 for the rotatable mounting of a clean-cloth roller 26, on which a clean washing cloth 28 is wound, and bearings 30 for a dirty-cloth roller 32 for winding up the respective dirty washing cloth section.

The dirty-cloth spindle 32 is provided with a freewheel drive 34, which rotates the dirty-cloth spindle 32 in each case and, as a result, transports the washing cloth onward from the clean-cloth roller 26 over a deflection plate 36 and the pressing element 6 by a predetermined washing cloth section 8 when the washing bar 2 is moved from the base position shown in FIG. 1 into the washing position, transversely with respect to the cylinder 4. In the washing position (not shown), the pressing element 6 presses the washing cloth section 8 against the peripheral surface 10 of the cylinder 4 and is slightly deformed as a result, as shown by the dashed lines 6-2. The freewheel drive 34 is designed in a similar way to a ratchet. It has a cloth driver lever 38 which, during the movement of the washing bar from the washing position (not shown) into the base position (shown), rests on a stop belonging to a holder and as a result is prevented from following the movement of the washing bar. During the reverse movement of the washing bar from the base position shown into the washing position (not shown), the stop releases the cloth driver lever 38, so that it can be moved back by the spring contained in it into the initial position, not rotating the dirty-cloth roller 32 during this reverse movement, because of its freewheel.

The reverse movement or freewheel movement of the cloth driver lever 38 is limited by a sensor lever 40, which is provided with a roller 42 which rides on the coil of washing cloth of the dirty-cloth spindle 34 and, as a result, determines the return distance in the freewheel direction of the cloth driver lever 38 as a function of the respective diameter of the dirty-cloth coil. This means that, irrespective of the coil diameters of the washing cloth on the two rollers 32 and 36 each advance step of the washing cloth is of approximately the same size.

On each side, the washing bar has two rollers 44 and 45, with which it can be moved between the base position and the washing position in guides belonging to a stationary holder.

A spray pipe 50 is arranged beside the movement path of the washing cloth 28 from the clean-cloth roller 26 to the pressing element 6, in order to moisten the washing cloth 28 by means of a curtain-like spray jet 52 from a very large number of very small nozzle holes 54 in the spray pipe 50.

The spray pipe 50 is inserted into a channel 56 in the upper outer holding bar 19 in FIG. 1 and is supported therein by the holding bar against deflection. The cross-sectional shape of the channel 56 is matched to the round shape of the spray pipe 50 and extends only partly, preferably by about 180°, around the spray pipe 50. The spray pipe 50 can be inserted radially into the channel 56, but according to the preferred embodiment, is pushed axially into the channel 56 and can also be pulled axially out of the latter.

As FIG. 2 shows, the spray pipe 50 is preferably detachably fastened to the cross member 20 only at its ends by means of a fastening means 58-1 and 58-2 in each case.

The fastening means 58-1 and 58-2 are preferably mirror-image or identical liquid connection elements, into which the ends of the spray pipe 50 are plugged in a liquid-tight manner. The seal is preferably achieved by means of O rings 60, which are pushed onto the pipe ends. The liquid connection elements 58-1 and 58-2 are connected to a liquid source 64 via liquid lines 62-1 and 62-2. From the liquid source 64, liquid, for example water, is then in each case sprayed onto the washing cloth 28 via the nozzle holes 54 of the spray pipe 50, during or shortly before the washing cloth 28 is moved one step further in relation to the pressing element 6. The spray jet 52 is preferably aimed into the inlet wedge between this washing cloth 28 and the pressing element 6.

In order to remove the spray pipe 50, only one of the two liquid connection elements 58-1 or 58-2 needs to be unscrewed from the cross member 20. The spray pipe 6 can then be pulled axially out of the other liquid connection element 58-1 or 58.2 and out of the channel 56 of the holding bar 19. This means there is very little mounting effort. According to another embodiment, the liquid connection element 58-1 or 58-2 to be taken away from one pipe end could also be arranged on the cross member 20 such that it can be displaced longitudinally. According to a still further embodiment, the liquid connection elements 58-1 and 58-2 could be detachably fastened to the outer holding bar 19, which carries the spray pipe 50, instead of to the cross member 20.

In all the embodiments there is the advantage that it is no longer necessary to loosen a large number of screws over the entire length of the washing bar, whose length corresponds to the length of the cylinder 4 to be cleaned, but only a single screw or another fastening element, with which the liquid connection element is fastened to the cross member 20 (or the outer holding bar 19).

According to other embodiments, there is also the possibility of forming only one of the two fastening means 58-1 and 58-2 as liquid connection elements, or neither of the two, if the liquid is fed to the spray pipe 50 in another way, for example at a point removed from the spray-pipe ends, for example at the center of the spray pipe.

The spray pipe 50 is preferably provided on its outer circumference with a flat 66, against which a positioning screw 68 presses, being screwed through the outer holding bar 19 which carries the spray pipe 50. As a result, the rotational angle position of the spray nozzle openings 54 relative to the holding bar 19 is defined. This positioner screw 68 must in each case be unscrewed if the spray pipe 50 is pulled out or inserted axially rather than radially from or into the channel 56 of the outer holding bar 19.

One and/or the other of the two outer holding bars 18 and 19 can be a single-part material piece together with the cross member 20.

FIGS. 5 and 6 show an embodiment in which both outer holding bars 18 and 19 are a one-part material piece together with the cross member 20. Furthermore, FIGS. 5 and 6 show a possible way of fastening the inner bar 12 detachably to the cross member 20 by means of quick-action fastening elements 70 instead of by means of screws 21. The quick-action fastening elements 70 can be pivoted on the inner bar 12 about an axis of rotation 72 which is mounted in the cross member 20.

The inner bar 12 can be formed in such a way that it engages laterally over the longitudinal edges 16, 17 of the preferably compressibly resilient pressing elements 6 and preferably clamps them against the cross member 20 and/or the outer holding bars 18, 19. For this purpose, the inner bar 12 can have lateral protrusions, for example with a vertical distance above the cross member 20, which engage over inner edge protrusions on the pressing element 6, or, as viewed in cross section, can have a dovetail shape or trapezoidal shape, the bar width being smallest close to the cross member 20 and becoming greater with increasing distance from the cross member.

Patent claims

1. A washing bar (2) for printing press cylinders (4), containing a pressing element (6) for pressing a washing cloth section (8) of a washing cloth (28) onto the peripheral surface (10) of a cylinder (4) to be cleaned, at least one holding element (18, 19) which extends over the entire length of the pressing element (6) and holds the pressing element (6) in a predetermined position, bearings (24, 30) for the rotatable mounting of a clean-cloth roller (26) and a dirty-cloth roller (32), in each case at their roller ends, in side parts (22), in order to move the washing cloth (28) from the clean-cloth roller (26) over the pressing element (6) onto the dirty-cloth roller (32), a spray pipe (50), which is arranged beside the movement path of the washing cloth (28) in order to moisten the washing cloth (28), characterized in that the spray pipe (50) is inserted into a channel (56) of the holding element (19) and is supported therein by the holding element against deflection, and in that fastening means (58-1, 58-2) are provided for the detachable fastening of the spray pipe (50) at both pipe ends.

2. The washing bar as claimed in claim 1, characterized in that the fastening means (58-1, 58-2) at at least one pipe end have a mount into which the pipe end can be inserted axially in a liquid-tight manner and from which it can be removed axially, and in that the fastening means (58-1, 58-2) of at least the relevant other pipe end is arranged such that it can be removed in such a way that after the removal of this fastening means (58-1, 58-2), the pipe (50) can be removed axially from the mount of the one fastening means (58-1, 58-2), and in that the fastening means (58-1, 58-2) at at least one pipe end is a liquid connection element for feeding liquid into the pipe end held by it.

3. The washing bar as claimed in claim 2, characterized in that the mount is a plug-in mount which, together with the relevant pipe end, forms a plug-in coupling.

4. The washing bar as claimed in one of the preceding claims, characterized in that the pipe (50) is arranged in the channel (56) of the holding element (19) so that it can be pulled out axially and plugged in axially.

5. The washing bar as claimed in one of the preceding claims, characterized in that the holding element (18, 19) is a clamping bar which, between itself and an inner bar (12), which is arranged in a cavity (14) formed at least partly by the pressing element (6) holds a longitudinal edge (16, 17) of the pressing element (6).

6. The washing bar as claimed in one of the preceding claims, characterized in that the holding element (18, 19) is fastened to a cross member (20), which connects the two side parts (22) to each other.

7. The washing bar as claimed in claim 6, characterized in that the fastening means (58-1, 58-2) are fastened to the cross member (20).

8. The washing bar as claimed in one of the preceding claims, characterized in that the spray pipe (50) is provided with a flat (66) on its outer periphery, against which a positioning screw (68) presses.

9. The washing bar as claimed in one of the preceding claims, characterized in that the cross-sectional shape of the channel (56) extends only partly around the spray pipe (50).

10. The washing bar as claimed in one of the preceding claims, characterized in that the cross-sectional shape of the channel (56) extends by approximately 180° around the spray pipe (50).
